(19) United States
(12) Patent Application Publication
(10) Pub. No.: US 2022/0192212 A1
(43) Pub. Date: Jun. 23, 2022

(54) SYSTEM, METHOD, AND APPARATUS FOR ON-SITE PROCESSING OF PLANT-BASED WASTE FOODS

(71) Applicant: OUTCAST FOODS INC., HALIFAX (CA)

(72) Inventor: DARREN BURKE, HALIFAX (CA)

(21) Appl. No.: 17/429,022

(22) PCT Filed: Feb. 7, 2020
(86) PCT No.: PCT/CA2020/050164

§ 371 Date: Aug. 6, 2021

Related U.S. Application Data
(60) Provisional application No. 62/803,247, filed on Feb. 8, 2019.

(51) Int. Cl. A23B 7/02; A23L 3/54; A23N 12/08; F26B 5/04; F26B 3/347; F26B 1/00

(52) U.S. Cl. CPC A23B 7/02; A23L 3/54; A23N 12/083; F26B 2200/02; F26B 3/347; F26B 1/005; F26B 5/04

(57) ABSTRACT

Disclosed herein are systems, methods, and apparatuses for on-site processing of plant-based waste foods, such as near-end-of-shelf-life produce, into dried compositions that are suitable for human consumption. In particular, there is provided a portable apparatus and methods for on-site processing of plant-based waste food into a dried composition that is suitable for human consumption.

### TECHNICAL FIELD

The present disclosure generally relates to systems and methods for reducing plant-based food waste. In particular, the present disclosure relates to systems, methods, and apparatuses for on-site processing of plant-based waste foods, such as near-end-of-shelf-life produce, into dried compositions that are suitable for human consumption.

### BACKGROUND

While many aspects of the modern food system are advancing at an impressive rate, food waste remains a largely intractable problem. For example, in North America alone, over 191 billion dollars of lost revenue is attributed to food waste on yearly basis. Plant-based foods—such as fruits, vegetables, roots, and tubers—have the highest wastage rates of all food types. Plant-based food waste is generated at a number of stages along a supply chain that links producers to consumers. In particular, plant-based food waste is often generated during production, processing, storage, transport, retail, and/or point of use. A significant part of this waste comes from plant-based foods that have substantial nutritional value and are still edible, but are unsuitable and/or undesirable for retail (for example due to ripeness, misshapenness, discoloration, and/or mismanagement).

Attempts have been made to capture at least a portion of the nutritional value of waste foods, most notably in the context of systems and methods for converting waste food into agricultural products such as fertilizers and/or animal feed. However, such processes are inherently inefficient in that they squander the energy and efforts required to advance plant-based waste foods along the supply chain towards human consumption. For example, fertilizer products aid in growing more food, which in turn could potentially end up back in the waste cycle. Moreover, the processes by which these types of products are carried through the supply chain (e.g. transportation and handling) leads to astronomical costs for governments and generates significant amounts of greenhouse gases.

A need exists for methods, systems and portable apparatuses for on-site processing of plant-based waste foods directly into dried sustainable food and/or nutrient products that are suitable for human consumption.

### SUMMARY

The present disclosure provides an alternate approach that does not remove plant-based waste foods from the food supply chain. In particular, the present disclosure provides systems, methods, and apparatuses for processing generally unsaleable plant-based foods into dried compositions that have extended shelf life and that are suitable for human consumption in other forms (such as nutritional supplements). Importantly, certain embodiments of the systems, methods, and apparatuses of the present disclosure are portable and configured to facilitate on-site processing at various stages along the supply chain. For example, the systems, methods, and apparatuses of the present disclosure may be utilized at a production center, a processing center, a storage center, a transport center, a retail center, and/or at point of use. The suitability of the systems, methods, and apparatuses of the present disclosure to multiple points along the supply chain relates to particular process engineering aspects that make the systems, methods, and apparatuses of the present disclosure self-contained and easy to operate—even by a non-specialized user.

Select embodiments of the present disclosure relate to a portable apparatus for on-site processing of plant-based waste food into a dried composition that is suitable for human consumption. The apparatus comprises a comminuting component that is configured to receive the plant-based waste food and to reduce the plant-based waste food to a particulate composition. The apparatus further comprises a dehydrating component that is configured to receive the particulate composition from the comminuting component, and dry the particulate composition to form the dried composition. The apparatus further comprises a container that houses the comminuting component and the dehydrating component such that the apparatus is portable and dimensioned for on-site delivery and processing. The comminuting component and the dehydrating component are configured to minimize nutritional loss and reduce spoilage such that the dried composition is suitable for human consumption over an extended period.

Select embodiments of the present disclosure relate to a method for on-site processing of plant-based waste food into a dried composition that is suitable for human consumption. The method comprises receiving a plant-based waste food in a comminution device, comminuting the plant-based waste food to produce a particulate composition; and dehydrating the particulate composition to form a dried composition. The comminuting and the dehydrating are carried out (i) in an apparatus that is portable and dimensioned for on-site delivery and processing; and (ii) to minimize nutritional loss and to reduce spoilage such that the dried composition is suitable for human consumption over an extended period.

Select embodiments of the present disclosure relate to a system for on-site processing of plant-based waste food into a dried composition that is suitable for human consumption. The system comprises a comminuting component that is configured to receive the plant-based waste food and to reduce the plant-based waste food to a particulate composition. The system further comprises a dehydrating component that is configured to receive the particulate composition from the comminuting component, and dry the particulate composition to form the dried composition. The comminuting component and the dehydrating component are configured to minimize nutritional loss and reduce spoilage such that the dried composition is suitable for human consumption over an extended period. In an embodiment, the system is a modular system comprising one or more modular components. In an embodiment, each of the modular components are portable and dimensioned for on-site delivery. In an embodiment, the modular system is dimensioned for on-site processing of the plant-based waste food into the dried composition.

Select embodiments of the present disclosure relate to a method for on-site processing of plant-based waste food into a dried composition that is suitable for human consumption. The method comprises receiving a plant-based waste food in a comminution device, comminuting the plant-based waste food to produce a particulate composition; and dehydrating the particulate composition to form a dried composition. The comminuting and the dehydrating are carried out to minimize nutritional loss and to reduce spoilage such that the dried composition is suitable for human consumption over an extended period. In an embodiment, the method is performed by a modular system comprising one or more modular components. In an embodiment, each of the modular components are portable and dimensioned for on-site delivery. In an embodiment, the modular system is dimensioned for on-site processing of the plant-based waste food into the dried composition.

### BRIEF DESCRIPTION OF THE DRAWINGS

These and other features of the present disclosure will become more apparent in the following detailed description in which reference is made to the appended figures and drawings. The appended figures and drawings illustrate one or more embodiments of the present disclosure by way of example only and are not to be construed as limiting the scope of the present disclosure.

FIG. 1 is a schematic representation of an apparatus in accordance with the present disclosure.

FIG. 2 is a flow diagram illustrating one example of a method in accordance with the present disclosure.

FIG. 3 shows a model of the vacuum microwave drying according to some embodiments of the present disclosure.

FIG. 4 shows results of vacuum microwave drying (VMD) experiments with near-end-of-shelf-life potatoes, varying minimum and maximum power.

FIG. 5 shows results of VMD experiments using near-end-of-shelf-life potatoes to study the impact of temperature on the dried product.

FIG. 6 shows results of VMD experiments using near-end-of-shelf-life bananas.

FIG. 7 shows results of VMD experiments using near-end-of-shelf-life blackberries.

### DETAILED DESCRIPTION

The present disclosure provides systems, methods, and apparatuses for processing plant-based waste foods that are unsuitable and/or undesirable for retail (e.g. unsaleable) into dried compositions that have extended shelf life and that are suitable for human consumption in other forms, such as for example dried powders, chips and nutritional supplements.

In some embodiments, the present disclosure provides a portable apparatus and system for on-site processing of plant-based waste food into a dried composition. The portability and modularity of the systems, methods and apparatuses disclosed herein allows for the collection and processing of plant-based waste foods on-site, prior to being transported to a waste management facility. This provides for a significant reduction in the transportation of waste, thereby saving costs while providing a new consumable product for human consumption.

An advantage of the disclosed systems, methods and apparatuses is thus the on-site reduction of food waste at the retail, farming and processing level, and direct conversion of plant-based waste foods on-site into another product that is suitable for human consumption.

Another advantage of the disclosed systems, methods and apparatuses is the creation of a dried powder or chip product from plant-based waste foods (e.g. fruits, vegetables, roots and pulses) into a product that can be packaged at point of use and provided back to grocers (e.g. sold to grocers) without wastages associated with transport and handling.

Another advantage of the disclosed systems, methods and apparatuses is the ability to directly convert plant-based waste foods on-site to a dried composition having substantially the same nutrient profile as the source food. In the context of the present disclosure, the term “nutrient profile” refers to the composition of nutritional components (e.g. vitamins, minerals, carbohydrates, etc.). The disclosed systems, methods and apparatuses are configured to minimize nutritional loss (e.g. retain substantially the same nutrient profile as the source food) and reduce spoilage such that the dried composition is suitable for human consumption over an extended period (e.g. good shelf-life). In the context of the present disclosure, “suitable for human consumption” refers to meeting criteria to be deemed safe for ingestion by a human, for example as defined by a regulatory body.

Another advantage of the disclosed systems, methods and apparatuses is the ability to generate high value products from unsaleable products. For example, the processing of plant-based waste foods into a dry powder that can be blended and made into an edible and highly nutritious vegan product. This product can re-enter the retail level as a high value, long-term shelf life product, thus leading to improved economic outcomes.

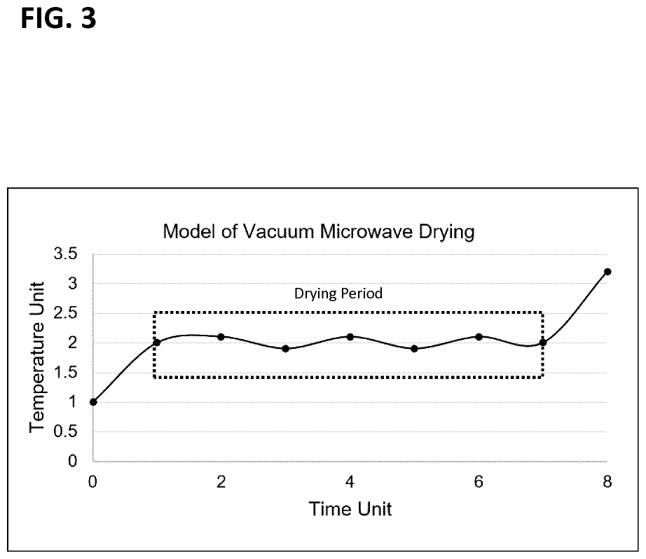

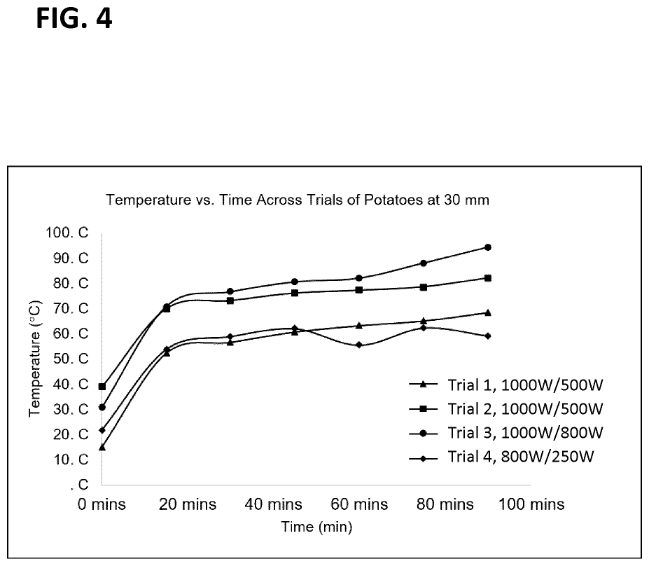

Another advantage of the disclosed systems, methods and apparatuses is the improved ability to convert a plant-based waste food into a dried composition that is suitable for human consumption, without significant loss. Embodiments of the systems, methods and apparatuses of the present disclosure operate in accordance with the model developed in Example 1 (FIG. 3), whereby a cyclical process involving parameters Pₘₐₓ, Pₘᵢₙ, Tₘₐₓ and Tₘᵢₙ is repeated until the desired product properties are achieved (e.g. a moisture content of less than 7.5%; FIGS. 4 to 7). The cyclical process avoids the generation of ash and provides a dried composition suitable for human consumption without significant wastage of the plant-base waste food being processed.

Another advantage of the disclosed systems, methods and apparatuses is that the dehydrating process removes waste water from the plant-based waste foods, which renders transportation of products more economical, including transportation, delivery and sale of the dried composition to a consumer.

Another advantage of certain embodiments of the disclosed systems, methods and apparatuses is their modularity and portability. In an embodiment, the apparatus disclosed herein is a self-contained unit comprising all of the necessary components to perform the disclosed methods. This apparatus is mobile and compact, such that it can be stored at retail, processing and distribution centers and the plant-based waste food can be processed directly into a dried composition on-site. In another embodiment, the systems as disclosed herein are modular systems, with individual modular components being portable and dimensioned for on-site delivery. The individual components can be arranged on-site as a modular system dimensioned for on-site processing.

Another advantage of the disclosed systems, methods and apparatuses is their ease of use. The systems, methods and apparatuses are easy for operators to use without any specific expertise. In particular, in an embodiment, the apparatus disclosed herein is a self-contained unit that provides all the necessary components to convert plant-based waste foods into a dried composition having an extended shelf life.

Another advantage of the disclosed systems, methods and apparatuses are embodiments that include a waste-stream processing unit. The waste-stream processing unit allows for the capture of by-products (e.g. CO₂, water, etc.) derived from processing the plant-based waste food. The waste-stream can be repurposed in a form that is suitable for each individual apparatus/system, depending on factors such as location and capacity.

Still other advantages and benefits of the systems, methods and apparatuses disclosed herein will become apparent to those skilled in the art upon a reading and understanding of the following detailed description.

In one aspect, the present disclosure relates to a portable apparatus for on-site processing of plant-based waste food into a dried composition that is suitable for human consumption, the apparatus comprising: a comminuting component that is configured to receive the plant-based waste food and to reduce the plant-based waste food to a particulate composition; a dehydrating component that is configured to receive the particulate composition from the comminuting component, and dry the particulate composition to form the dried composition; and a container that houses the comminuting component and the dehydrating component such that the apparatus is portable and dimensioned for on-site delivery and processing, wherein the comminuting component and the dehydrating component are configured to minimize nutritional loss and reduce spoilage such that the dried composition is suitable for human consumption over an extended period.

Associated with the above aspect, in an embodiment the present disclosure relates to a method for on-site processing of plant-based waste food into a dried composition that is suitable for human consumption, the method comprising: receiving a plant-based waste food in a comminution device; comminuting the plant-based waste food to produce a particulate composition; and dehydrating the particulate composition to form a dried composition, wherein the comminuting and the dehydrating are carried out: (i) in an apparatus that is portable and dimensioned for on-site delivery and processing; and (ii) to minimize nutritional loss and to reduce spoilage such that the dried composition is suitable for human consumption over an extended period.

As such, select embodiments of the present disclosure relate to a portable apparatus for on-site processing of plant-based waste food into a dried composition suitable for human consumption. In other embodiments, the present disclosure relates to a system for on-site processing of plant-based waste food into a dried composition suitable for human consumption.

In another aspect, the present disclosure relates to a system for on-site processing of plant-based waste food into a dried composition that is suitable for human consumption, the system comprising: a comminuting component that is configured to receive the plant-based waste food and to reduce the plant-based waste food to a particulate composition; and a dehydrating component that is configured to receive the particulate composition from the comminuting component, and dry the particulate composition to form the dried composition; wherein the comminuting component and the dehydrating component are configured to minimize nutritional loss and reduce spoilage such that the dried composition is suitable for human consumption over an extended period.

Associated with the above aspect, in an embodiment the present disclosure relates to a method for on-site processing of plant-based waste food into a dried composition that is suitable for human consumption, the method comprising: receiving a plant-based waste food in a comminution device; comminuting the plant-based waste food to produce a particulate composition; and dehydrating the particulate composition to form a dried composition, wherein the comminuting and the dehydrating are carried out to minimize nutritional loss and to reduce spoilage such that the dried composition is suitable for human consumption over an extended period.

As used herein, the term “particulate composition” is meant to refer to plant-based waste food that has been reduced into smaller pieces (e.g. fragmented). The size reduction may be, for example, by crushing, milling, grinding, cutting, slicing, macerating, vibrating, or any other suitable process. The particulate composition may comprises any shape or form. In some embodiments of the present disclosure, the particulate composition is in the form of slices as cut by, for example, a knife or a slicer. In some embodiments, the particulate composition comprises a granular form. In some embodiments, the particulate composition comprises a non-uniform particle size distribution. In other embodiments, the particulate composition comprises pieces of relatively similar or homogenous shapes and sizes.

In the context of the present disclosure, an “apparatus” is a contained unit or system in which all of the components of the disclosed methods are contained within a single portable structure. This may otherwise be referred to herein as a “pod”. The pod is portable and dimensioned for delivery to a desired site for on-site processing of the plant-based waste food into a dried composition. By “portable” it is meant that the apparatus may be moved from one location to another, such as by truck, rail or any other means of ground or sea transportation.

In an embodiment, the portable structure of the apparatus is a container. The container houses the other components of the apparatus and is dimensioned for portability. The container may be any number of designs and embodiments. In an embodiment, the container is any closed-unit structure capable of housing the other components of the apparatus. In an embodiment, the container of the type of a shipping container/intermodal container (e.g. a sea can container or an ISO shipping container), a flatbed truck trailer, or a mobile office-type trailer. In an embodiment, the container is similar in structure to an intermodal container.

In an embodiment, the container may be a newly manufactured and purpose-built container for the apparatus and methods disclosed herein. In another embodiment, the container may be one that is recycled and/or repurposed to meet the requirements of the apparatus and methods the present disclosure.

The container may be of any suitable size so long as it is capable of housing the other components of the apparatus and methods disclosed herein, including minimally the comminuting component and the dehydrating component. In an embodiment, the container is about 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 feet in length. In a particular embodiment, the container is about 20, 40 or 48 feet in length. In an embodiment, the container is about 4.0, 4.5, 5.0, 5.5, 6.0, 6.5, 7.0, 7.5, 8.0, 8.5, 9.0, 9.5 or 10.0 feet in width. In a particular embodiment, the container is about 8-feet wide. In an embodiment, the container is about 6.0, 6.5, 7.0, 7.5, 8.0, 8.5, 9.0, 9.5 or 10.0 feet in height. In a particular embodiment, the container is about 8.5-feet tall.

At any desired location for on-site processing, one or more apparatuses of the present disclosure may be combined. This may be advantageous as the needs of the customer grow such that greater processing capacity is required and/or more diversified systems are needed (e.g. to produce multiple different dried compositions at the same time at one site). In an embodiment, the containers (e.g. pods) of the apparatuses of the present disclosure may be of a suitable configuration or structure to be stacked on top of one another. In an embodiment, the containers (e.g. pods) of the apparatuses of the present disclosure may be of a suitable configuration or structure to be interconnected side-by-side. In such side-by-side embodiments, one or more walls of the containers may be removed to generate a larger united container housing two or more of the apparatuses or systems disclosed herein.

At any desired location for on-site processing, one or more apparatuses of the present disclosure may be modified to meet the needs of the customer and/or consumer. An example of such modification is the generation of combined units as described above. The apparatuses may also be modified in any number of other ways. In an embodiment, the apparatuses as disclosed herein may be modified by removal of one or more walls or the roof. Such embodiments may be beneficial in adjoining the apparatus to a building structure at the desired location for on-site processing. In an embodiment, the apparatus may be modified to include a door in one or more walls of the container or an access panel for throughput of the food-based waste food. In an embodiment, different sized containers of the apparatuses disclosed herein may be modified such that the different sized containers can be combined as a single unit or modified in any other manner to be positioned side-by-side or stacked. Various other modifications may be made and are encompasses herein.

In the context of the present disclosure, a “system” is a set of components that work together as an interconnected network to perform the methods disclosed herein. In contrast to an “apparatus” as disclosed herein, the components of the system need not be housed within a single portable unit (e.g. container). Rather, the one or more components of the system may be separately positioned and/or delivered and set up at a desired site to provide the on-site processing of plant-based waste foods into a dried powder.

In an embodiment, the system disclosed herein is a “modular system”. By “modular system”, it is meant that the components of the system that perform the methods disclosed herein are modular components. By “modular component”, it is meant to refer to an independent unit that is portable and dimensioned for delivery to a desired site, and which can be used to construct the more complex structure of the system disclosed herein. Each modular component may comprise one or more of the components of the system disclosed herein. In some embodiments, when the modular components are combined to provide the disclosed system, the system as a whole is dimensioned for on-site processing of the plant-based waste food into the dried composition.

For modular systems, as disclosed herein, it is a preferable embodiment that each modular component be easily connected to the other modular components for ease in assembling the disclosed system. In an embodiment, the modular components may be capable of interconnection to one another.

In the context of the present disclosure, “on-site processing” refers to the processing of the plant-based waste food into a dried composition at the source site of the plant-based waste food. The source site may, for example, be a production, processing, storage, transport, retail, and/or point of use site. In a particular embodiment, on-site is at a retail or grocer location, a food distribution facility, a food processing facility or a farm. In a particular embodiment, on-site is at a retail or grocer location. In other embodiments, the on-site location may be a collection center or facility for plant-based waste food or a centralized food processing facility. The collection center or centralized food processing facility is preferably in close proximity to production, processing, storage, transport, retail, and/or point of use sites. By “on-site processing”, it is also meant that all of the steps of the disclosed methods occur at a single site.

As used herein, “plant-based waste food” refers to any plant-based food that is considered to be waste. By “waste”, it is meant for example that the plant-based food is unsuitable and/or undesirable for retail (e.g. unsaleable) or for any other food supply chain (e.g. charitable food program). The plant-based waste food may be unsaleable/unusable for any number of reasons, including without limitation ripeness, misshapenness, discoloration, impurities, product expiry, and/or mismanagement of the food somewhere along the chain of production, processing, distribution and/or retail. As used herein, the term “waste” is not intended to mean that the food is not edible or that the food is devoid of nutritional value. Rather, in a preferred embodiment, the plant-based waste food is edible and still has considerable nutritional value. A plant-based waste food is, in essence, any plant-based food that absent the systems, methods, and apparatuses of the present disclosure, would be removed from the retail supply chain or other food supply chain.

In some embodiments, the plant-based waste food is a near-end-of-shelf-life food product. As used herein, a “near-end-of-shelf-life food product” is a plant-based food that is still edible and saleable, but is undesirable for sale due to one or more characteristics as described herein (e.g. ripeness, misshapenness, discoloration, impurities, etc.). The near-end-of-shelf-life food product still has a nutritional value.

The plant-based waste food may be any type of plant-based food, including without limitation a vegetable, a fruit, a grain, a root, a legume, a pulse or any other food derived in whole or in part from a plant. In a particular embodiment, the plant-based waste food is a vegetable, a fruit, a grain or any combination thereof.

Prior to processing in the methods, systems and apparatuses disclosed herein, different types of pant-based waste foods may be sorted into Zero Waste Bins that a unique for each type of plant-based food. For example, the bins or their lids may be colour-coded for easy sorting of different types of plant based foods. As an example, a green bin or lid for leafy greens; a yellow bin or lid for root vegetables, such has carrots, potatoes and beets; a purple bin or lid for fruits such as apples, oranges and grapes; and a blue bin or lid for packaged produce. The bins may be any suitable size or shape. In an embodiment, the bins are about 42.5″×48″×28″. The bins may be placed in designated areas for easy collection and/or easy processing in the methods, systems and apparatuses disclosed herein. In an embodiment, the bins are heavy duty, have insulated walls and a secure sealed lid to increase the life of the plant-based waste food inside, reduce rodent access, and prevent insect proliferation.

The systems, methods and apparatuses disclosed herein relate to the on-site processing of a plant-based waste food into a dried composition that is suitable for human consumption. By “dried composition”, it is meant that the product is substantially free of water or completely free of water. In this regard, in an embodiment, the dried composition has a moisture content of less than 15%, 14%, 13%, 12%, 11%, 10%, 9%, 8%, 7%, 6%, 5%, 4%, 3%, 2%, 1%, or 0.5% by weight. In an embodiment, the dried composition has a moisture content of between 3.5% and 15% by weight. In an embodiment, the dried composition has a moisture content of between 10% and 15% by weight. In an embodiment, the dried composition has a moisture content of between 5% and 10% by weight. In an embodiment, the dried composition has a moisture content of less than 10% by weight. In a particular embodiment, the dried composition has a moisture content of less than 7.5%. In a more particular embodiment, the dried composition has a moisture content of less than 5% by weight. In an even more particular embodiment, the dried composition has a moisture content of less than 1% by weight. In an embodiment, the dried composition is free of water.

In an embodiment, the dried composition is a dry powder. In another embodiment, the dried composition is a snackfood product, such as a chip, a cracker, or a snack-bar. In an embodiment, the dried composition is a vegan food in that the dried composition does not contain any animal products.

In the systems, methods, and apparatuses disclosed herein, a preferred embodiment is that the dried composition has substantially the same nutrient profile as that of the source plant-based waste food. The systems, methods, and apparatuses are capable of achieving this by their particular arrangement of components and ability for rapid on-site processing of the plant-based waste food into the dried composition, without significant loss of product. In an embodiment, by “substantially the same” nutrient profile it is meant that during the course of processing there is a less than 10%, 9%, 8%, 7%, 6%, 5%, 4%, 3%, 2% or 1% loss of nutrients (by weight) in the dried composition as compared to the source plant-based waste food. In an embodiment, the loss of nutrients is less than 5%.

A dried composition prepared using the systems, methods and apparatuses as disclosed herein has an extended shelf life. In the context of the present disclosure, “shelf life” refers to the length of time the dried composition prepared using the systems, methods and apparatuses of the present disclosure can be stored without becoming unsuitable for human consumption. In an embodiment, the shelf life of the dried composition is between 1 and 36 months. In an embodiment, the shelf life of the dried composition is between 3 and 24 months. In an embodiment, the shelf life of the dried composition is at least 6 months. In an embodiment, the shelf life of the dried composition is at least 1 year. In an embodiment, and particularly where the dried composition is vacuum-sealed in an airtight package, shelf life of the dried composition is at least 2 years. In an exemplary embodiment, the formation of mold is indicative of a product that is not suitable for human consumption.

The systems, methods, and apparatuses disclosed herein comprise a comminuting component. The comminuting component is configured to receive the plant-based waste food and to reduce the plant-based waste food to a particulate composition. In some embodiments, by “configured to receive”, it is meant that the comminuting component receives the plant-based waste food either directly into the comminuting component or indirectly via other components, such as a receiving hopper and conveyer belt. In other embodiments, the comminuting component is configured to receive the plant-based waste food by manual transfer; e.g. an operator providing the plant-based waste food to the comminuting component. The comminuting component may be any device that grinds, crushes, cuts, chops, slices, mills, macerates, or otherwise reduces the plant-based waste food into smaller pieces.

In an embodiment, the comminuting component comprises a grinding unit, a crushing unit, a cutting unit, a slicing unit, a milling unit, a macerating unit, a hydro-pulping unit, or a combination thereof. In a particular embodiment, the comminuting component comprises a slicing unit. Suitable slicing units are available and an exemplary embodiment includes the TranSlicer® 2510 Cutter (Urschel, USA), the Comitrol® Processor Model 1700 (Urschel, USA) or the Sprint 2® Dicers (Urschel, USA). In a particular embodiment, the comminuting component comprises a grinding unit. Grinding units are available and an exemplary embodiment includes the Comitrol® Processor Model 3600F (Urschel, USA).

In a particular embodiment, the comminuting component comprises both a slicing unit and a grinding unit. The slicing unit is used as a pre-treatment step to cut the plant-based waste food into manageable sized pieces before grinding. The grinding unit is use to produce a homogenous slurry for subsequent dehydration. If the plant-based waste food is already a small size, then the slicing unit could be omitted. Likewise, depending for example on the desired dried composition (e.g. a chip product), the grinding unit could be omitted and the sliced plant-based waste food processed directly by the dehydrating component.

The systems, methods, and apparatuses disclosed herein further comprise a dehydrating component. As used herein, a “dehydrating component” is synonymous with a “dryer”. The dehydrating component is used to efficiently dry and remove moisture from the plant-based waste food that has been processed by the comminuting component. In this regard, the dehydrating component is configured to receive the particulate composition from the comminuting component, and dry the particulate composition to form a dried composition. In some embodiments, by “configured to receive”, it is meant that the dehydrating component receives the particulate composition either directly from the comminuting component or indirectly via other components, such as a transfer structure (e.g. a pipe). In other embodiments, the dehydrating component is configured to receive the plant-based waste food that has been processed by the comminuting component by manual transfer; e.g. an operator providing the particulate composition to the dehydrating component. In an embodiment, the dehydrating component comprises an oven unit, a vacuum unit, a fan unit, a freeze-drying unit, or a combination thereof. In a particular embodiment, the dehydrating component employs microwave-assisted drying. In an embodiment, the dehydrating component is a vacuum microwave dryer or a continuous vacuum belt dryer. In a particular embodiment, the dehydrating component is a vacuum microwave dryer or a similar drying apparatus that efficiently dries a plant-based waste food (e.g. produce) while avoiding nutrient loss.

Many different types of dehydrating machines or dryers are available, including without limitation the Puschner Batch Vacuum Dryer (Puschner, Germany), the WaveMix™ (Marion, USA), the Talin™ microwave drying machine (TalinTech, China), the MONA™ infrared conveyor belt vacuum dryer (MONA, China), and the Devex™ continuous vacuum belt dryer (DEVEX, Germany).

In some embodiments of the present disclosure, the dehydrating component of the systems, methods, and apparatuses disclosed herein is a vacuum microwave dryer. In the context of the present disclosure, “vacuum microwave dryer” refers to a machine that uses microwave radiation to generate heat in a chamber that is under reduced pressure (i.e. under a vacuum). By reducing the pressure, water in the contents of the chamber (e.g. in the plant-based waste food) can evaporate at a lower temperature than at atmospheric pressure. An advantage of lower temperature water evaporation is that the nutrients in the plant-based waste food may be substantially unaltered.

In some embodiments, the vacuum microwave dryer of the systems, methods, and apparatuses disclosed herein comprises an automated control system that regulates power (P), temperature (T), and optionally other parameters. In some embodiments, the automated control system is configured to receive inputs comprising a maximum power (Pₘₐₓ), a minimum power (Pₘᵢₙ), a maximum temperature (Tₘₐₓ), and a minimum temperature (Tₘᵢₙ). In some embodiments, the Pₘₐₓ and the Pₘᵢₙ maintain the temperature in the vacuum microwave dryer between a Tₘᵢₙ of about 55° C. and a Tₘₐₓ of about 65° C. throughout a drying period.

In the context of the present disclosure, the term “drying period” refers to the period of time in which the temperature within the chamber of the vacuum microwave dryer oscillates between Tₘᵢₙ and Tₘₐₓ. A non-limiting example of the drying period is shown in FIG. 3.

In some embodiments, the Pₘᵢₙ and Pₘₐₓ are each of a power that provides a moisture content of between 0% and 7.5% by weight in the dried composition during the drying period. In some embodiments, the Pₘₐₓ is between about 750 W and about 1000 W and the Pₘᵢₙ is about 250 W.

In some embodiments, the systems, methods, and apparatuses disclosed herein may further comprise one or more of a receiving hopper, a conveyor belt, a milling unit (e.g. a fine-powder milling component), a packaging station, or any combination thereof.

In some embodiments, the systems, methods, and apparatuses herein may comprise a receiving hopper. A receiving hopper may be used to collect the plant-based waste food from an environment external to the apparatus or system disclosed herein (e.g. from a retail outlet at which the apparatus is located). In such embodiments, the receiving hopper is the component whereby the plant-based waste foods enters the processing line of the apparatus and system disclosed herein. In an embodiment, the plant-based waste food is cleaned before being deposited in the receiving hopper. In an alternate embodiment, the plant-based waste food may be cleaned in the receiving hopper.

The receiving hopper should be capable of receiving large inputs of plant-based waste food. In an embodiment, the access opening to the receiving hopper is at least about 1 ft², 2 ft², 3 ft², 4 ft², 5 ft², or larger. In a particular embodiment, the access opening to the receiving hopper is about 2 ft². Many embodiments of receiving hoppers are known and available. In an embodiment, the receiving hopper is as sold by Carlsen & Associates (California, USA).

In some embodiments, the systems, methods, and apparatuses herein may comprise a conveyor belt. For example, a conveyor belt may be used to transport the plant-based waste food from a receiving hopper to a comminuting component. In another embodiment, the conveyor belt may act as the receiving component and deliver the plant-based waste food to the comminuting component.

In some embodiments, the systems, methods, and apparatuses herein may comprise a milling unit. Milling units are known and readily available. In an embodiment, the milling unit is a fine-powder milling component. Embodiments in which such a component may particularly be useful are those in which a dry powder product is the desired end-product, or a desired intermediary product. The fine-powder milling component can be used to convert the dried cuts (after slicing) or the dried slurry (after grinding) into a homogenous powder. In an embodiment, a hammer mill may be used as the fine-powder milling component. Many different types of fine-powder milling machines are available, including without limitation the Comitrol® Processor Model 1700 (Urschel, USA).

In some embodiments, the systems, methods, and apparatuses herein may comprise a packaging station. In such embodiments, the packaging station comprises a packaging system that is configured for packaging the dried composition into a package. In an embodiment, the package is an airtight package. In an embodiment, the packaging is a sustainable packaging. By “sustainable packaging” it is meant the use of packaging that results from improved sustainability. In an embodiment, the sustainable packaging may be a recycled packaging or a packaging made from a renewable resource. In an embodiment, the sustainable packaging may itself be a recyclable packaging. The sustainable packaging reduces the environmental and/or ecological footprint in comparison to a more conventional type of packaging. In an embodiment, the package is an airtight sustainable package.

In a particular embodiment, the portable apparatus of the present disclosure comprises the following components: a receiving hopper, a slicer unit, a dehydrating component (i.e. dryer), a milling unit, and a packaging station. In an embodiment, the dehydrating component is a vacuum microwave dryer such as described herein. In an embodiment, the milling unit is a fine-powder milling component such as described herein.

Building on the eco-friendly aspects of the systems, methods, and apparatuses disclosed herein, in some embodiments the systems, methods, and apparatuses may further comprise a waste-stream processing unit. As used herein, “waste-stream” refers to a by-product or waste product from employing the methods as disclosed herein. Without limitation, the waste-stream may be CO₂ and/or water. The waste-stream processing unit captures these waste-streams and stores and/or re-uses them for an alternate purpose. In an embodiment, the waste-stream processing unit comprises one or more storage units that store the waste-streams. In an embodiment, the water waste may be re-cycled back into the methods disclosed herein, such as during the comminution step to provide a slurry. In an embodiment, the CO₂ waste may be used as a food additive or as a cooling agent.

In some embodiments, the systems, methods, and apparatuses herein may comprise an automatic process controller. The automatic process controller may be configured to execute instructions for processing the plant-based waste food. The automatic process controller may be any conventional processor, microcontroller or state machine. The automatic process controller may form part of a computing device. The automatic process controller may be designed to receive signals from other components of the systems, methods and apparatuses disclosed herein, and respond to these signals to adjust the operation of the methods disclosed herein.

In some embodiments, the systems, methods, and apparatuses herein may comprise a flow control. The flow control may exchange signals with the automatic process controller and mediate the flow of plant-based waste food through the processing stages provided by the systems, methods and apparatuses disclosed herein. In another embodiment, the flow control may moderate the importation of a waste-stream into the processing steps of the systems, methods and apparatuses disclosed herein, such as the addition of water to the comminuting component to provide the slurry.

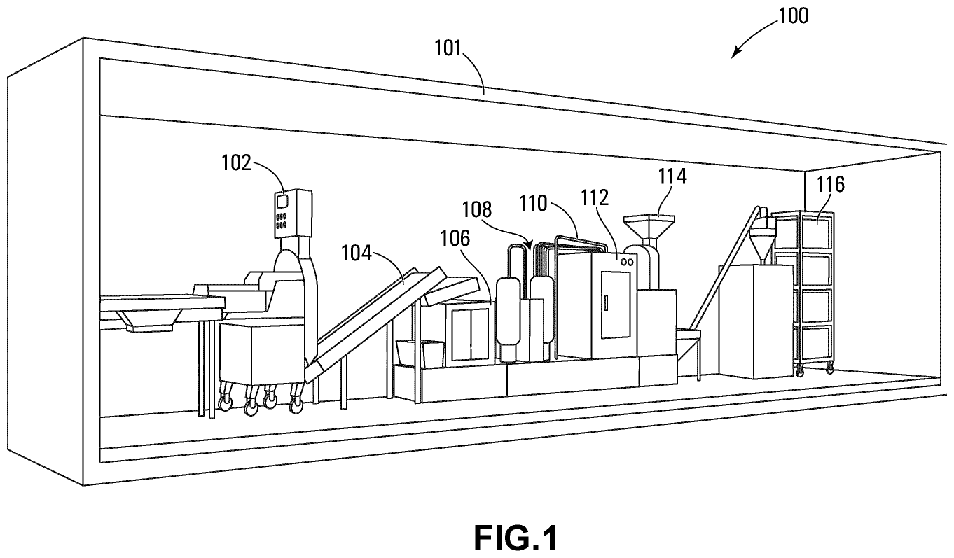

Embodiments of the present disclosure will now be described by reference to FIG. 1 which is a schematic representation of a portable apparatus 100 in accordance with the present disclosure. The portable apparatus 100 comprises a container 101, a receiving hopper 102, a conveyor belt 104, a slicing unit 106, a grinding unit 108, a conduit 110, a vacuum microwave dryer 112, a milling unit 114 (e.g. a fine-powder packaging component), and a packaging station 116. The receiving hopper 102, the conveyor belt 104, the slicing unit 106, the grinding unit 108, the conduit 110, the vacuum microwave dryer 112, the milling unit 114, and the packaging station 116 are arranged in sequence to provide a continuous stream that processes plant-based waste food to a dried composition that is suitable for human consumption.

The container 101 houses each of the other components, such that the apparatus 100 is self-contained and portable. The container 101 is dimensioned for on-site delivery and processing in that it has: (i) a length of about 20 feet to about 50 feet, preferably 20 feet, 40 feet or 48 feet, (ii) a width of about 8 feet to about 9 feet, preferably about 8 feet, and (iii) a height of about 8 feet to about 9 feet, preferably about 8.5 feet, such that the apparatus 100 meets standard truck and/or rail transportation size restrictions.

The receiving hopper 102 is configured to collect plant-based waste food. The conveyor belt 104 is configured to transport plant-based waste foods from the receiving hopper 102 to the slicing unit 106. The slicing unit 106 is configured to slice plant-based waste foods into smaller pieces that are suitable for passing into the grinding unit 108. The grinding unit 108 is configured to process the smaller pieces into a homogenous slurry. The conduit 110 is configured to allow passage of the homogeneous slurry from the grinding unit 108 to the vacuum microwave dryer 112. The vacuum microwave dryer 112 is configured to dehydrate the homogeneous slurry into a dried composition. In an embodiment, the vacuum microwave dryer 112 dehydrates the homogeneous slurry at a low temperature to mitigate against nutrient loss by heat-induced degradation. The milling unit 114 is configured to receive the dried composition from the vacuum microwave dryer 112 and to mill the dried composition into a homogeneous powder. The packaging station 116 is configured for dispensing the homogeneous powder into one or more packages which are suitable for providing to a retailer or directly to an end-user for human consumption.

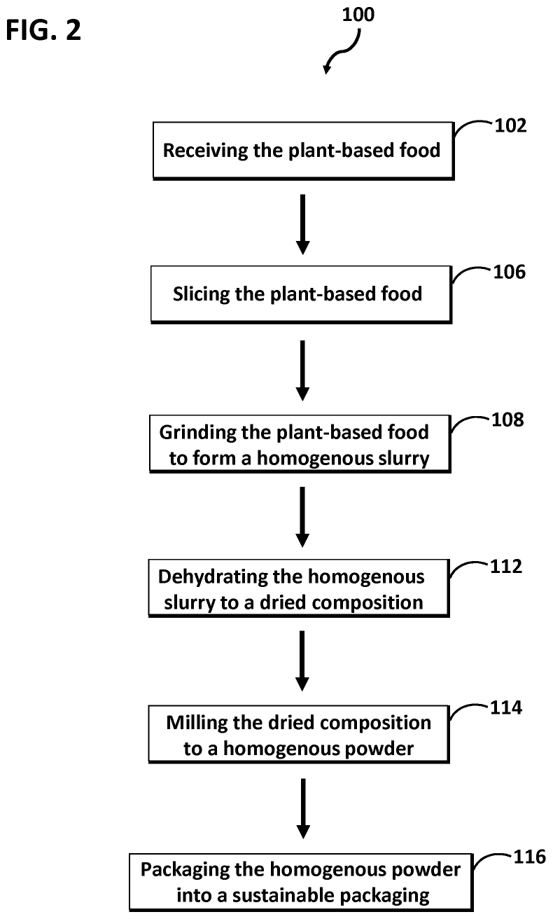

The methods of the present disclosure may be further described by reference to FIG. 2, which is a flow diagram illustrating one example of a method in accordance with the present disclosure.

Referring to FIG. 2, an exemplary method in accordance with the present disclosure comprises the sequential steps of:
i) collecting the plant-based waste food in a receiving hopper 102;
ii) transporting the plant-based waste food from the receiving hopper 102 to a slicing unit 106 on a conveyor belt 104;
iii) slicing the plant-based waste food in the slicing unit 106 to produce a pre-treated food material (e.g. to increase surface area of the plant-based waste food);
iv) grinding, in a grinding unit 108, the pre-treated food material into a homogenous slurry;
v) transferring the homogenous slurry, via a conduit 110, to a dehydrating component, such as a vacuum microwave dryer 112;
vi) dehydrating the homogenous slurry to produce the dried composition;
vii) milling the dried composition, in a milling unit 114 (e.g. a fine-powder milling component), to produce a homogenous powder; and
viii) packaging the homogenous powder, at a packaging station 116, into a sustainable packaging.

Exemplary equipment that may be used in the methods according to the invention are described elsewhere herein. Depending on the type of plant-based waste food, it may be preferable to exclude step (iv) above where the sliced plant-based waste food is subjected to grinding to form a homogenous slurry.

Non-limiting examples of the processing of plant-based waste foods (e.g. potatoes, bananas, and blackberries) according to the systems and methods of the present disclosure are found in FIG. 4 to FIG. 7 and described in the Examples below.

The methods herein provide a means to directly take plant-based food that is to be wasted and convert it into a high nutrient, dry product that has a long-term shelf life. The methods can be portably deployed at retail, processing and/or distribution centers by use of the apparatus (e.g. pod) disclosed herein, so that the plant-based waste food can be processed into a dried product on-site.

In the present disclosure, all terms referred to in singular form are meant to encompass plural forms of the same. Likewise, all terms referred to in plural form are meant to encompass singular forms of the same. Unless defined otherwise, all technical and scientific terms used herein have the same meaning as commonly understood by one of ordinary skill in the art to which this disclosure pertains.

As used herein, the term “about” refers to an approximately +/−10% variation from a given value. It is to be understood that such a variation is always included in any given value provided herein, whether or not it is specifically referred to.

It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Although individual embodiments are discussed, the disclosure covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure. If there is any conflict in the usages of a word or term in this specification and one or more patent(s) or other documents that may be incorporated herein by reference, the definitions that are consistent with this specification should be adopted.

Many obvious variations of the embodiments set out herein will suggest themselves to those skilled in the art in light of the present disclosure. Such obvious variations are within the full intended scope of the appended claims.

### EXAMPLES

### Example 1

A model for the thermodynamic behavior of near-end-of-shelf-life produce subjected to Vacuum Microwave Drying (VMD) was developed.

Within the dryer, there is an automated control system that regulates power (P), and temperature (T). A maximum and minimum temperature (Tₘₐₓ and Tₘᵢₙ, respectively; ° C.) and power (measured in watt; W) to be adhered to during operation must be inputted. The closed loop control system of the VMD will emit microwave radiation at Pₘₐₓ until it reaches Tₘₐₓ. At the point of Tₘₐₓ achievement, the dryer lowers its emission power to Pₘᵢₙ until it reaches Tₘᵢₙ at which point it changes power emission back to Pₘₐₓ. This cyclical process is repeated until the desired product properties are achieved.

To develop the model of VMD-based drying, the thermodynamic cycles were analyzed. The model was based on various concepts and assumptions, including that heating the produce to Tₘₐₓ would result in evaporation of free water in the produce (e.g. unbound water brought to the surface) and application of microwaves would result in liberation and evaporation of cellular moisture. Since the microwaves penetrated the near-end-of-shelf-life produce, it was anticipated that the organic material as a whole (i.e. not only the surface), would begin to dry resulting in a rise and fall behavior in a plot of temperature versus time. It was predicted that, once all of the water in the produce was removed, the produce itself would excessively increase in temperature since the water's heat capacity would no longer be able to buffer the produce from the microwaves' effects. Based on this behavior, the model for VMD of near-end-of-shelf-life produce shown in FIG. 3 was developed.

Using this model, tracking the temperature over time allowed for operations to be terminated once a given trial increased significantly past Tₘₐₓ. Additionally, if the produce was relatively sensitive to heat, the drying process was designed to terminate at an appropriate time prior to the expected surpassing of Tₘₐₓ; e.g. at approximately 10% prior to the expected surpassing.

### Example 2

Based on several recorded experiments using VMD, a methodology for the drying of near-end-of-shelf-life produce was developed. A VMD with a power rating of 20 kW was used for all experiments in this and the following examples.

The impact of Pₘᵢₙ and Pₘₐₓ was studied using near-end-of-shelf-life potatoes with a slice thickness of about 30 mm. An appropriate temperature in the dryer needed to be maintained so as to retain nutritional and aesthetic quality of the produce, and provide a shelf-stable end-product. As was determined experimentally, Pₘᵢₙ needed to be high enough to promote the evaporation of water from within the produce while also being low enough to decrease the temperature in the dryer when the dryer changed from Pₘₐₓ. Through experiments varying power, it was found that a Pₘᵢₙ of 250 W gave the rise and fall behavior desired by the model in Example 1 (FIG. 4).

With respect to Pₘₐₓ, a minimum wattage was found to be beneficial to liberate water from the cells of the respective produce. For example, an experiment using near-end-of-shelf-life zucchini (data not shown) failed to effectively dry the produce using Pₘₐₓ 400 W and Pₘᵢₙ 300 W, despite a run time of 360 minutes. Based on several similar experiments, it was estimated that Pₘₐₓ of 750 W-1000 W is sufficient for breaking down the cell walls of the produce to liberate water. It was also found that the respective cell walls need to be penetrated instantaneously after the free moisture was removed for efficient drying

### Example 3

A series of VMD experiments were performed using near-end-of-shelf-life potatoes to develop a correlation between temperature and drying time. In a typical experiment, the closed loop control system of the VMD emitted microwave radiation at Pₘₐₓ until it reached Tₘₐₓ. At the point of Tₘₐₓ achievement, the dryer lowered its emission power to Pₘᵢₙ until it reached Tₘᵢₙ at which point it changed power emission back to Pₘₐₓ.

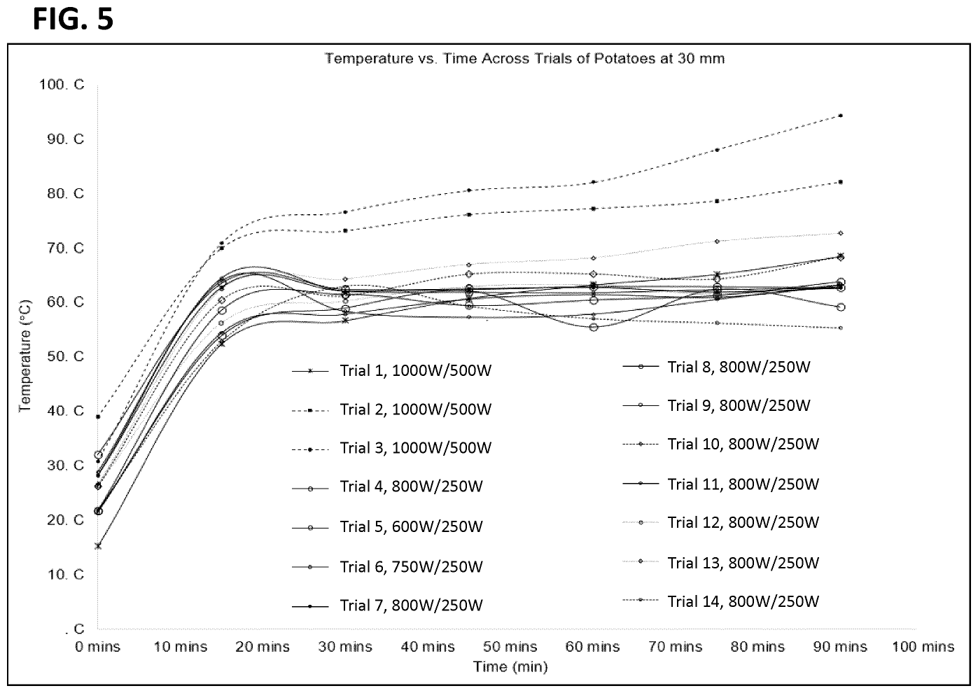

As shown in FIG. 5, one of the trials exceeded 70° C. within the first 20 minutes of operation. In this trial, scorched produce resulted that was not suitable for human consumption. In contrast, trials in which the temperature was maintained between 55° C. and 65° C. by the calculated VMD emission powers Pₘₐₓ and Pₘᵢₙ led to dried produce with appropriate moisture and sensory quality, a product suitable for human consumption, and a product having desired shelf-stable qualities.

### Example 4

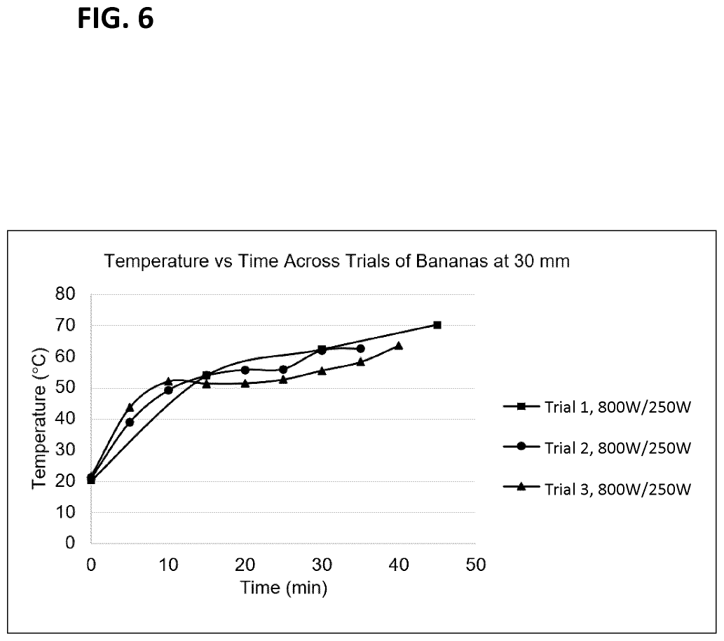

A series of VMD experiments were performed using near-end-of-shelf-life bananas (FIG. 6). In a typical experiment, the closed loop control system of the VMD emitted microwave radiation at Pₘₐₓ until it reached Tₘₐₓ. At the point of Tₘₐₓ achievement, the dryer lowered its emission power to Pₘᵢₙ until it reached Tₘᵢₙ at which point it changed power emission back to Pₘₐₓ. Temperatures exceeding 65° C. gave a product containing ash levels considered to be unsuitable for human consumption, further confirming that VMD temperatures above 65° C. yielded a suboptimal dried product. In contrast, two of the three experiments performed using the calculated Pₘₐₓ and Pₘᵢₙ fell within the parameters of the model of Example 1.

### Example 5

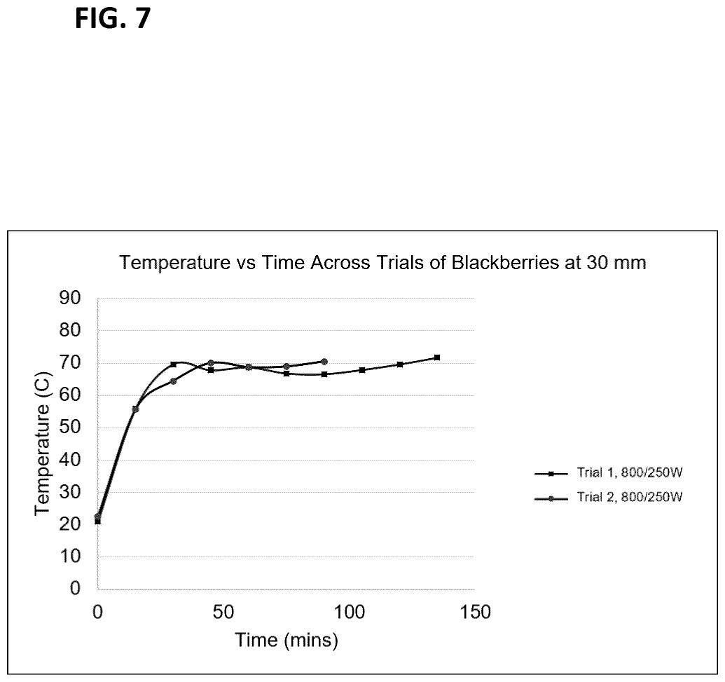

A series of VMD experiments were performed using near-end-of-shelf-life blackberries (FIG. 7). In a typical experiment, the closed loop control system of the VMD emitted microwave radiation at Pₘₐₓ until it reached Tₘₐₓ. At the point of Tₘₐₓ achievement, the dryer lowered its emission power to Pₘᵢₙ until it reached Tₘᵢₙ at which point it changed power emission back to Pₘₐₓ. Similar scorching was observed when temperatures exceeded 70° C. as was seen with other produce (e.g. bananas; Example 4).

Based on the experiments using VMD for the drying of late life produce, the limit for internal temperature was determined to be 65° C. and the following parameters were established for the VMD methodology:

| Parameter | | Value/Range |
|---|---|---|
| Variable | Maximum Temperature | 65° C. |
| Inputs | Minimum Temperature | 55° C. |
| | Maximum Microwave Power | 750-1000 W |
| | Minimum Microwave Power | 250 W |
| | Thickness of Input Produce | 10-30 mm |
| | Size Reduction Method | Various |
| Outcome | Final Moisture Content | 0-7.5% |

### Example 6

The impact of thickness of the near-end-of-shelf-life produce on drying was studied. A wet product thickness of 50 mm failed to effectively dry the input produce, likely because the microwaves were unable to effectively penetrate the entirety of the produce. By reducing the produce thickness to a range of 10-30 mm effective drying was achieved (e.g. as in the above examples). The impact of the type of slice was also studied but no significant difference between slices was observed. However, it was found that it was beneficial to have the starting produce placed in VMD trays such that there was consistent airflow. In cases of insufficient airflow, moisture pockets accumulated and uneven drying occurred. Further, moisture trapped within the overlaid produce was found to accumulate on the tray below, compromising the produced contained within.

### Example 7

A powder obtained from the methods of the present disclosure, comprising equal parts kale, lettuce, parsley, and green onion, was analyzed and found to have a moisture content of 5.37%. Correlating this finding to the model of Example 1 resulted in the conclusion that operating by initiating machine shutdown and pressure release when Tₘₐₓ was exceeded was beneficial to achieve the targeted moisture content.

1.-48. (canceled)

49. A system for on-site processing of plant-based waste food into a dried composition that is suitable for human consumption, the system comprising:
a comminuting component that is configured to receive the plant-based waste food and to reduce the plant-based waste food to a particulate composition; and
a dehydrating component that is configured to receive the particulate composition from the comminuting component, and dry the particulate composition to form the dried composition;
wherein the comminuting component and the dehydrating component are configured to minimize nutritional loss and reduce spoilage such that the dried composition is suitable for human consumption over an extended period.

50. The system of claim 49, further comprising a fine-powder milling component configured for receiving the dried particulate composition and converting to the dried particulate composition into a homogeneous powder.

51. The system of claim 49, which is a modular system comprising one or more modular components.

52. The system of claim 51, wherein each of the modular components are portable and dimensioned for on-site delivery.

53. The system of claim 52, wherein the modular system is dimensioned for on-site processing of the plant-based waste food into the dried composition.

54. The system of claim 49, wherein the plant-based waste food is a near-end-of-shelf-life food product.

55. The system of claim 54, wherein the plant-based waste food comprises a vegetable, a fruit, a grain, or a combination thereof.

56. The system of claim 49, wherein the dried composition is a powder, a chip, or a vegan food.

57. (canceled)

58. (canceled)

59. The system of claim 49, wherein the nutrient profile of the dried composition is substantially the same as that of the plant-based waste food that is comminuted.

60. The system of claim 49, wherein the dried composition has a shelf life of between about 1 month and about 36 months.

61. The system of claim 49, wherein:
the comminuting component comprises a grinding unit, a crushing unit, a cutting unit, a slicing unit, a milling unit, a macerating unit, a hydro-pulping unit, or a combination thereof; and
the dehydrating component comprises an oven unit, a vacuum unit, a fan unit, a freeze-drying unit, or a combination thereof.

62. (canceled)

63. The system of claim 61, wherein the dehydrating component is a vacuum microwave dryer.

64. The system of claim 63, wherein the vacuum microwave dryer comprises an automated control system, and the automated control system is configured to receive inputs comprising a maximum power (Pₘₐₓ), a minimum power (Pₘᵢₙ), a maximum temperature (Tₘₐₓ), and a minimum temperature (Tₘᵢₙ).

65. (canceled)

66. The system of claim 64, wherein the Pₘₐₓ and the Pₘᵢₙ maintain the temperature in the vacuum microwave dryer between a Tₘᵢₙ of about 55° C. and a Tₘₐₓ of about 65° C. throughout a drying period.

67. The system of claim 66, wherein the Pₘᵢₙ and Pₘₐₓ are each of a power that provides a moisture content of between 0% and 7.5% by weight in the dried composition during the drying period.

68. The system of claim 67, wherein the Pₘₐₓ is between about 750 W and about 1000 W and the Pₘᵢₙ is about 250 W.

69. (canceled)

70. The system of claim 49, further comprising one or more of:
a receiving hopper, a conveyor belt or a combination thereof configured for receiving and providing the plant-based waste food to the comminuting component;
a packaging station configured for packaging the dried composition into an airtight sustainable packaging;
an automatic process controller; and
a flow control.

71. (canceled)

72. The system of claim 49, which comprises a receiving hopper, a slicer unit as the comminuting component, the dehydrating component, a milling unit, and a packaging station.

73. (canceled)

74. (canceled)

75. The system of claim 49, further comprising a waste-stream processing unit that is configured to process a waste stream derived from processing the plant-based waste food, wherein the waste stream comprises CO₂, water, or a combination thereof.

76. (canceled)

77. The system of claim 49, wherein on-site processing occurs at a food retail site, a food distribution facility, a collection center, a food processing facility or a farm.

78.-100. (canceled)
